(19) United States
(12) Patent Application Publication
(10) Pub. No.: US 2025/0335170 A1
(43) Pub. Date: Oct. 30, 2025

(54) FINE GRAINED TELEMETRY SHARING

(71) Applicant: Snowflake Inc., Bozeman, MT (US)

(72) Inventors: Damien Carru, New York, NY (US); Benoit Dageville, San Carlos, CA (US); Yutian Feng, Toronto (CA); Unmesh Jagtap, San Mateo, CA (US); Xiaodi Ke, Markham (CA); Subramanian Muralidhar, Mercer Island, WA (US); Jan Michael Timmerman, Guelph (CA); Sohail Zafar, Bothell, WA (US)

(21) Appl. No.: 18/645,294

(22) Filed: Apr. 24, 2024

(51) Int. Cl. G06F 8/61

(52) U.S. Cl. CPC G06F 8/61

(57) ABSTRACT

Disclosed are techniques for selectively sharing with a provider account of a data exchange, events generated by an application shared by the provider account. A set of telemetry definitions may be defined for a data listing via which an application is shared by a provider account of a data sharing platform. Each of the set of telemetry definitions specifies a type of event generated by the application and a corresponding sharing requirement for the type of event. The set of telemetry definitions are persisted as metadata associated with the data listing. The application may be installed in a consumer account of the data exchange. In response to the application generating a plurality of events, a subset of the plurality of events may be shared with the provider account, wherein the subset of the plurality events that is shared is based in part on the set of telemetry definitions.

### TECHNICAL FIELD

The present disclosure relates to sharing applications via data sharing platforms, and particularly to techniques for customizing what shared application-generated events are shared.

### BACKGROUND

Databases are widely used for data storage and access in computing applications. Databases may include one or more tables that include or reference data that can be read, modified, or deleted using queries. Databases may be used for storing and/or accessing personal information or other sensitive information. Secure storage and access of database data may be provided by encrypting and/or storing data in an encrypted form to prevent unauthorized access. In some cases, data sharing may be desirable to let other parties perform queries against a set of data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram depicting an example computing environment in which the methods disclosed herein may be implemented, in accordance with some embodiments of the present invention.

FIG. 1B is a block diagram illustrating an example virtual warehouse, in accordance with some embodiments of the present invention.

FIG. 2 is a schematic block diagram of data that may be used to implement a public or private data exchange, in accordance with some embodiments of the present invention.

FIG. 3 is a schematic block diagram of deployment of a data exchange that illustrates consumer and provider managed data access techniques, in accordance with some embodiments of the present invention.

FIG. 4A is a block diagram of a deployment of a data exchange, illustrating application sharing techniques, in accordance with some embodiments of the present invention.

FIG. 4B is a diagram illustrating example telemetry definitions, in accordance with some embodiments of the present invention.

FIG. 4C is a diagram illustrating an example user interface for making event sharing preference selections, in accordance with some embodiments of the present invention.

FIGS. 5A-5D are block diagrams of a deployment of a data exchange configured for selective sharing of events generated by an application shared via the data exchange, in accordance with some embodiments of the present invention.

FIG. 6 is a block diagram of a method for selectively sharing with a provider account of a data exchange, events generated by an application shared by the provider account via the data exchange, in accordance with some embodiments of the present invention.

FIG. 7 is a block diagram of an example computing device that may perform one or more of the operations described herein, in accordance with some embodiments of the present invention.

### DETAILED DESCRIPTION

Data providers often have data assets that are cumbersome to share. A data asset may be data that is of interest to another entity. For example, a large online retail company may have a data set that includes the purchasing habits of millions of consumers over the last ten years. This data set may be large. If the online retailer wishes to share all or a portion of this data with another entity, the online retailer may need to use old and slow methods to transfer the data, such as a file-transfer-protocol (FTP), or even copying the data onto physical media and mailing the physical media to the other entity. This has several disadvantages. First, it is slow as copying terabytes or petabytes of data can take days. Second, once the data is delivered, the provider cannot control what happens to the data. The recipient can alter the data, make copies, or share it with other parties. Third, the only entities that would be interested in accessing such a large data set in such a manner are large corporations that can afford the complex logistics of transferring and processing the data as well as the high price of such a cumbersome data transfer. Thus, smaller entities (e.g., “mom and pop” shops) or even smaller, more nimble cloud-focused startups are often priced out of accessing this data, even though the data may be valuable to their businesses. This may be because raw data assets are generally too unpolished and full of potentially sensitive data to simply outright sell/provide to other companies. Data cleaning, de-identification, aggregation, joining, and other forms of data enrichment need to be performed by the owner of data before it is shareable with another party. This is time-consuming and expensive. Finally, it is difficult to share data assets with many entities because traditional data sharing methods do not allow scalable sharing for the reasons mentioned above. Traditional sharing methods also introduce latency and delays in terms of all parties having access to the most recently-updated data.

Private and public data exchanges may allow data providers to more easily and securely share their data assets with other entities. A public data exchange (also referred to herein as a “Snowflake data marketplace,” or a “data marketplace”) may provide a centralized repository with open access where a data provider may publish and control live and read-only data sets to thousands of consumers. A private data exchange (also referred to herein as a “data exchange”) may be under the data provider's brand, and the data provider may control who can gain access to it. The data exchange may be for internal use only, or may also be opened to consumers, partners, suppliers, or others. The data provider may control what data assets are listed as well as control who has access to which sets of data. This allows for a seamless way to discover and share data both within a data provider's organization and with its business partners.

The data exchange may be facilitated by a cloud computing service such as the SNOWFLAKE™ cloud computing service, and allows data providers to offer data assets directly from their own online domain (e.g., website) in a private online marketplace with their own branding. The data exchange may provide a centralized, managed hub for an entity to list internally or externally-shared data assets, inspire data collaboration, and also to maintain data governance and to audit access. With the data exchange, data providers may be able to share data without copying it between companies. Data providers may invite other entities to view their data listings, control which data listings appear in their private online marketplace, control who can access data listings and how others can interact with the data assets connected to the listings. This may be thought of as a “walled garden” marketplace, in which visitors to the garden must be approved and access to certain listings may be limited.

As an example, Company A may be a consumer data company that has collected and analyzed the consumption habits of millions of individuals in several different categories. Their data sets may include data in the following categories: online shopping, video streaming, electricity consumption, automobile usage, internet usage, clothing purchases, mobile application purchases, club memberships, and online subscription services. Company A may desire to offer these data sets (or subsets or derived products of these data sets) to other entities. For example, a new clothing brand may wish to access data sets related to consumer clothing purchases and online shopping habits. Company A may support a page on its website that is or functions substantially similar to a data exchange, where a data consumer (e.g., the new clothing brand) may browse, explore, discover, access and potentially purchase data sets directly from Company A. Further, Company A may control: who can enter the data exchange, the entities that may view a particular listing, the actions that an entity may take with respect to a listing (e.g., view only), and any other suitable action. In addition, a data provider may combine its own data with other data sets from, e.g., a public data exchange (also referred to as a “data marketplace”), and create new listings using the combined data.

A data exchange may be an appropriate place to discover, assemble, clean, and enrich data to make it more monetizable. A large company on a data exchange may assemble data from across its divisions and departments, which could become valuable to another company. In addition, participants in a private ecosystem data exchange may work together to join their datasets together to jointly create a useful data product that any one of them alone would not be able to produce. Once these joined datasets are created, they may be listed on the data exchange or on the data marketplace.

Sharing data may be performed when a data provider creates a share object (hereinafter referred to as a share) of a database in the data provider's account and grants the share access to particular objects (e.g., tables, secure views, and secure user-defined functions (UDFs)) of the database. Then, a read-only database may be created using information provided in the share. Access to this database may be controlled by the data provider. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. The consumer accounts with which the database and its objects are shared may be indicated by a list of references to those consumer accounts contained within the share object. Only those consumer accounts that are specifically listed in the share object may be allowed to look up, access, and/or import from this share object. By modifying the list of references of other consumer accounts, the share object can be made accessible to more accounts or be restricted to fewer accounts.

In some embodiments, each share object contains a single role. Grants between this role and objects define what objects are being shared and with what privileges these objects are shared. The role and grants may be similar to any other role and grant system in the implementation of role-based access control. By modifying the set of grants attached to the role in a share object, more objects may be shared (by adding grants to the role), fewer objects may be shared (by revoking grants from the role), or objects may be shared with different privileges (by changing the type of grant, for example to allow write access to a shared table object that was previously read-only). In some embodiments, share objects in a provider account may be imported into the target consumer account using alias objects and cross-account role grants.

When data is shared, no data is copied or transferred between users. Sharing is accomplished through the cloud computing services of a cloud computing service provider such as SNOWFLAKE™. Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share).

A data exchange may also implement role-based access control to govern access to objects within consumer accounts using account level roles and grants. In one embodiment, account level roles are special objects in a consumer account that are assigned to users. Grants between these account level roles and database objects define what privileges the account level role has on these objects. For example, a role that has a usage grant on a database can “see” this database when executing the command “show databases”; a role that has a select grant on a table can read from this table but not write to the table. The role would need to have a modify grant on the table to be able to write to it.

Because consumers of data often require the ability to perform various functions on data that has been shared with them, a data exchange may enable users of a data marketplace to build native applications that can be shared with other users of the data marketplace. The native applications can be published and discovered in the data marketplace like any other data listing, and consumers can install them in their local data marketplace account to serve their data processing needs. This helps to bring data processing services and capabilities to consumers instead of requiring a consumer to share data with e.g., a service provider who can perform these data processing services and share the processed data back to the consumer. Stated differently, instead of a consumer having to share potentially sensitive data with a third party who can perform the necessary data processing services and send the results back to the consumer, the desired data processing functionality may be encapsulated, and then shared with the consumer so that the consumer does not have to share their potentially sensitive data.

Monitoring native applications running in consumer accounts is important both for providers and consumers. Event sharing between native application providers and consumers is crucial for observability, troubleshooting, and transparent data governance. Providers want to support their applications running in consumer accounts by having access to events generated by their applications. Events may include for example errors and warnings, metrics, usage logs, debug logs, and query audit logs. These events can help a provider understand how consumers use their shared applications. In addition, when a provider shares an application (e.g., by creating a listing for it in the data exchange), they may include usage metrics in the metadata of the listing so that consumers will have visibility into the resources consumed by the application and can set quotas to adequately budget for the required resource consumption. For example, the provider may provide an indication of the resources (e.g., compute, storage resources) required to run the application in the listing metadata and any consumers interested in the application may set their respective quotas accordingly.

However, current event sharing mechanisms face several limitations hindering seamless workflows. For example, current sharing mechanisms have limited visibility, meaning providers don't have enough data to measure ROI, troubleshoot, and support their customers due to a lack of critical APM and associated logs. Current sharing mechanisms also suffer from a lack of adequate controls. More specifically, providers lack controls to adjust event sharing visibility, duration or apply governance policies on certain event fields. This reduces flexibility in balancing data access and privacy. Providers thus cannot indicate what events data sharing is mandatory for, and what events data sharing is optional for (e.g., may provide better experience but not necessary for accessing shared application).

On the consumer side, consumers must manually create event tables and manage access policies. This is cumbersome and prone to misconfigurations that create security issues. There are also insufficient security features. For example, granting access to the event table is done on an “all or nothing” basis for consumers and consumers lack fine-grained controls to mask sensitive fields or adjust sharing duration. This potentially exposes excessive data. For example, a consumer who only wants to share metrics data and not log data, or only wants to share log data that is error data, but not usage data or debug data does not have an adequate mechanism for doing so. Consumer enterprise infosec must review and approve an application, which includes knowing what logs are shared and the level of control/access a provider has.

Embodiments of the present disclosure address the above and other issues by providing techniques for selectively sharing with a provider account of a data exchange, events generated by an application shared by the provider account. A set of telemetry definitions may be defined for a data listing via which an application is shared by a provider account of a data sharing platform. Each of the set of telemetry definitions specifies a type of event generated by the application and a corresponding sharing requirement for the type of event. The set of telemetry definitions are persisted as metadata associated with the data listing. The application may be installed in a consumer account of the data exchange. In response to the application generating a plurality of events, a subset of the plurality of events may be shared with the provider account, wherein the subset of the plurality events that is shared is based in part on the set of telemetry definitions.

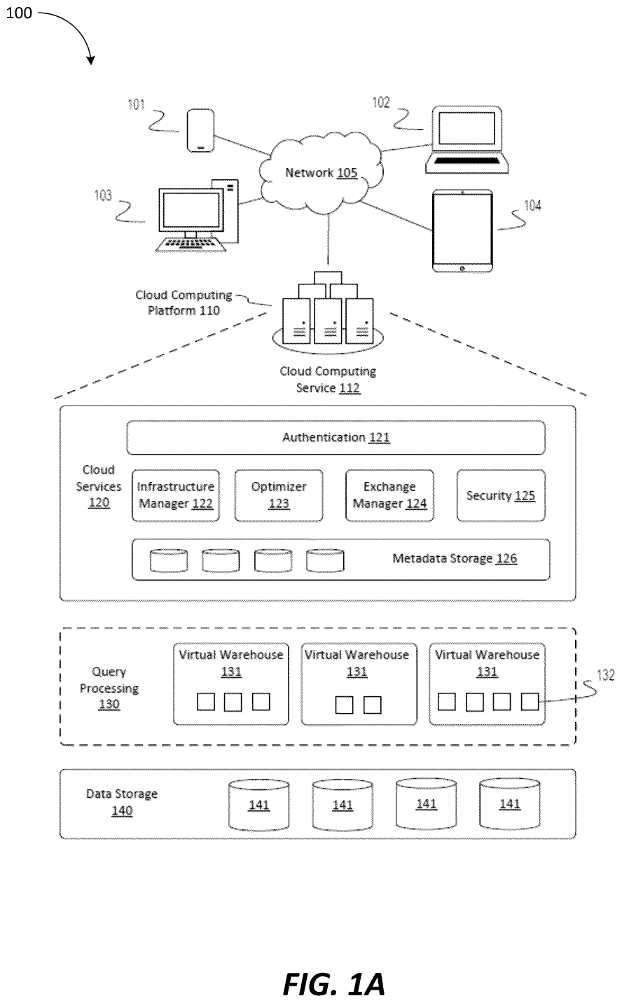

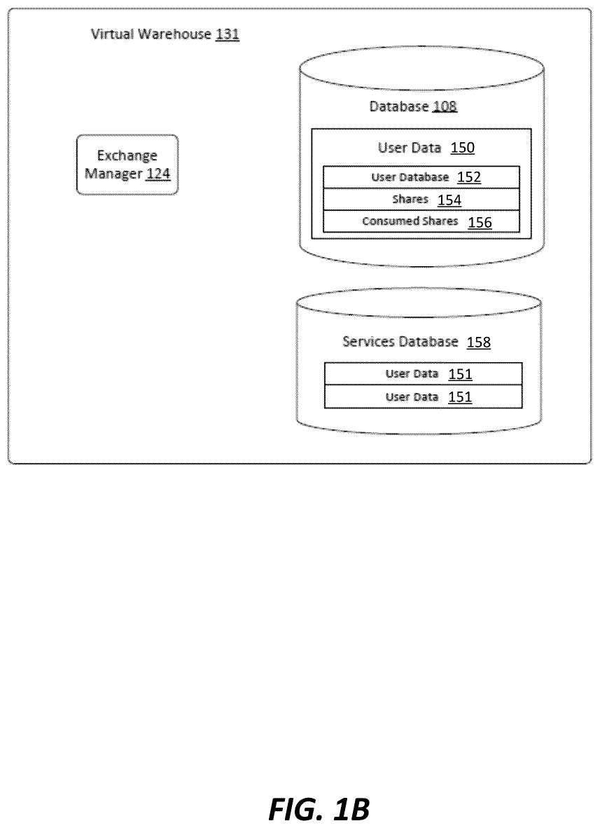

FIG. 1A is a block diagram of an example computing environment 100 in which the systems and methods disclosed herein may be implemented. A cloud computing platform 110 may be implemented, such as Amazon Web Services™ (AWS), Microsoft Azure™, Google Cloud™, or the like. As known in the art, a cloud computing platform 110 provides computing resources and storage resources that may be acquired (purchased) or leased and configured to execute applications and store data.

The cloud computing platform 110 may host a cloud computing service 112 that facilitates storage of data on the cloud computing platform 110 (e.g. data management and access) and analysis functions (e.g. SQL queries, analysis), as well as other computation capabilities (e.g., secure data sharing between users of the cloud computing platform 110). The cloud computing platform 110 may include a three-tier architecture: data storage 140, query processing 130, and cloud services 120.

Data storage 140 may facilitate the storing of data on the cloud computing platform 110 in one or more cloud databases 141. Data storage 140 may use a storage service such as Amazon S3™ to store data and query results on the cloud computing platform 110. In particular embodiments, to load data into the cloud computing platform 110, data tables may be horizontally partitioned into large, immutable files which may be analogous to blocks or pages in a traditional database system. Within each file, the values of each attribute or column are grouped together and compressed using a scheme sometimes referred to as hybrid columnar. Each table has a header which, among other metadata, contains the offsets of each column within the file.

In addition to storing table data, data storage 140 facilitates the storage of temp data generated by query operations (e.g., joins), as well as the data contained in large query results. This may allow the system to compute large queries without out-of-memory or out-of-disk errors. Storing query results this way may simplify query processing as it removes the need for server-side cursors found in traditional database systems.

Query processing 130 may handle query execution within elastic clusters of virtual machines, referred to herein as virtual warehouses or data warehouses. Thus, query processing 130 may include one or more virtual warehouses 131, which may also be referred to herein as data warehouses. The virtual warehouses 131 may be one or more virtual machines operating on the cloud computing platform 110. The virtual warehouses 131 may be compute resources that may be created, destroyed, or resized at any point, on demand. This functionality may create an “elastic” virtual warehouse that expands, contracts, or shuts down according to the user's needs. Expanding a virtual warehouse involves generating one or more compute nodes 132 to a virtual warehouse 131. Contracting a virtual warehouse involves removing one or more compute nodes 132 from a virtual warehouse 131. More compute nodes 132 may lead to faster compute times. For example, a data load which takes fifteen hours on a system with four nodes might take only two hours with thirty-two nodes.

Cloud services 120 may be a collection of services that coordinate activities across the cloud computing service 112. These services tie together all of the different components of the cloud computing service 112 in order to process user requests, from login to query dispatch. Cloud services 120 may operate on compute instances provisioned by the cloud computing service 112 from the cloud computing platform 110. Cloud services 120 may include a collection of services that manage virtual warehouses, queries, transactions, data exchanges, and the metadata associated with such services, such as database schemas, access control information, encryption keys, and usage statistics. Cloud services 120 may include, but not be limited to, authentication engine 121, infrastructure manager 122, optimizer 123, exchange manager 124, security engine 125, and metadata storage 126.

FIG. 1B is a block diagram illustrating an example virtual warehouse 131. The exchange manager 124 may facilitate the sharing of data between data providers and data consumers, using, for example, a data exchange. For example, cloud computing service 112 may manage the storage and access of a database 108. The database 108 may include various instances of user data 150 for different users e.g., different enterprises or individuals. The user data 150 may include a user database 152 of data stored and accessed by that user. The user database 152 may be subject to access controls such that only the owner of the data is allowed to change and access the user database 152 upon authenticating with the cloud computing service 112. For example, data may be encrypted such that it can only be decrypted using decryption information possessed by the owner of the data. Using the exchange manager 124, specific data from a user database 152 that is subject to these access controls may be shared with other users in a controlled manner. In particular, a user may specify shares 154 that may be shared in a public or data exchange in an uncontrolled manner or shared with specific other users in a controlled manner as described above. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. When data is shared, no data is copied or transferred between users. Sharing is accomplished through the cloud services 120 of cloud computing service 112.

Sharing data may be performed when a data provider creates a share of a database in the data provider's account and grants access to particular objects (e.g., tables, secure views, and secure user-defined functions (UDFs)). Then a read-only database may be created using information provided in the share. Access to this database may be controlled by the data provider.

Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share). A secure join may be performed as described in U.S. application Ser. No. 16/368,339, filed Mar. 18, 2019.

User devices 101-104, such as laptop computers, desktop computers, mobile phones, tablet computers, cloud-hosted computers, cloud-hosted serverless processes, or other computing processes or devices may be used to access the virtual warehouse 131 or cloud service 120 by way of a network 105, such as the Internet or a private network.

In the description below, actions are ascribed to users, particularly consumers and providers. Such actions shall be understood to be performed with respect to devices 101-104 operated by such users. For example, notification to a user may be understood to be a notification transmitted to devices 101-104, an input or instruction from a user may be understood to be received by way of the user's devices 101-104, and interaction with an interface by a user shall be understood to be interaction with the interface on the user's devices 101-104. In addition, database operations (joining, aggregating, analysis, etc.) ascribed to a user (consumer or provider) shall be understood to include performing of such actions by the cloud computing service 112 in response to an instruction from that user.

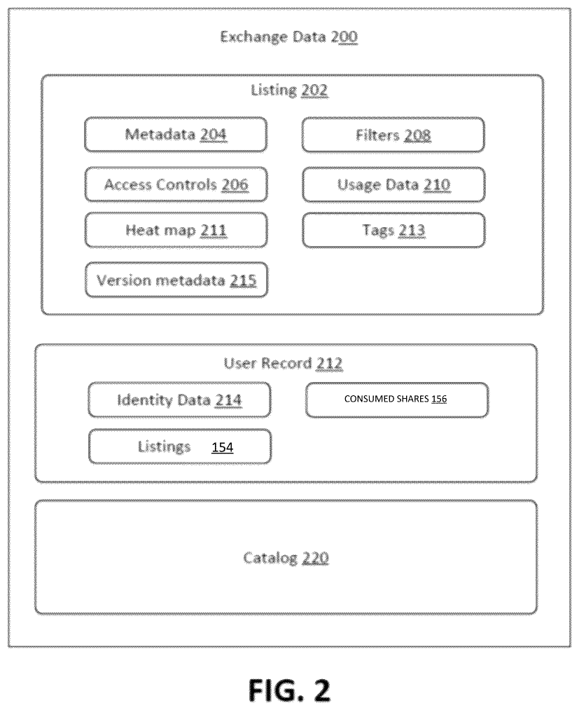

FIG. 2 is a schematic block diagram of data that may be used to implement a public or data exchange in accordance with an embodiment of the present invention. The exchange manager 124 may operate with respect to some or all of the illustrated exchange data 200, which may be stored on the platform executing the exchange manager 124 (e.g., the cloud computing platform 110) or at some other location. The exchange data 200 may include a plurality of listings 202 describing data that is shared by a first user (“the provider”). The listings 202 may be listings in a data exchange or in a data marketplace. The access controls, management, and governance of the listings may be similar for both a data marketplace and a data exchange.

The listing 202 may include access controls 206, which may be configurable to any suitable access configuration. For example, access controls 206 may indicate that the shared data is available to any member of the private exchange without restriction (an “any share” as used elsewhere herein). The access controls 206 may specify a class of users (members of a particular group or organization) that are allowed to access the data and/or see the listing. The access controls 206 may specify that a “point-to-point” share in which users may request access but are only allowed access upon approval of the provider. The access controls 206 may specify a set of user identifiers of users that are excluded from being able to access the data referenced by the listing 202.

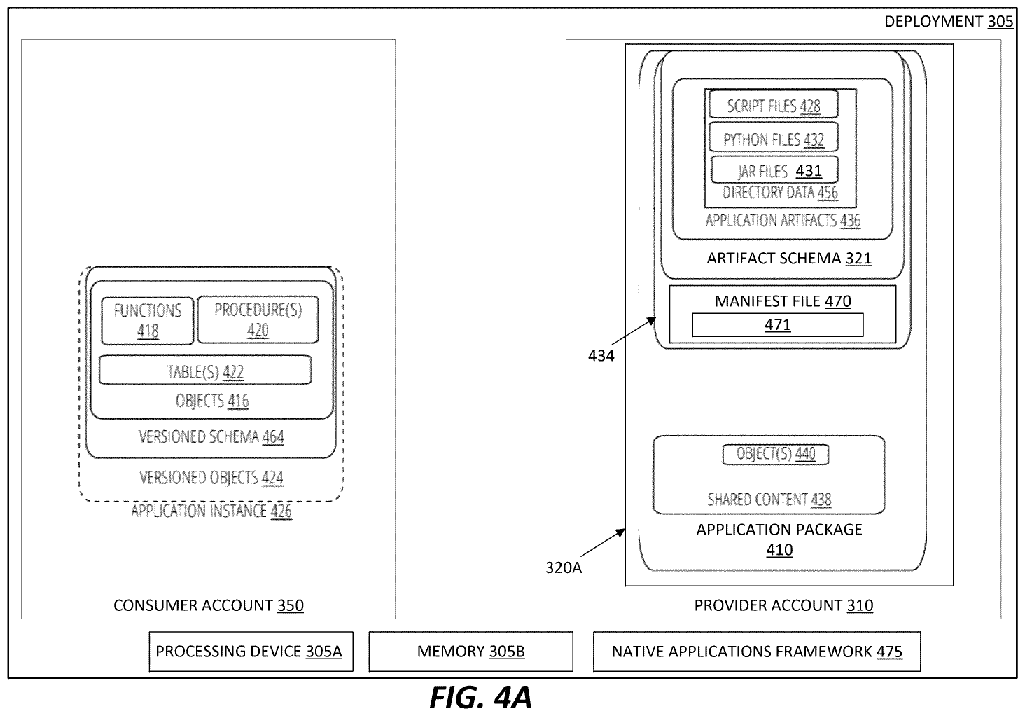

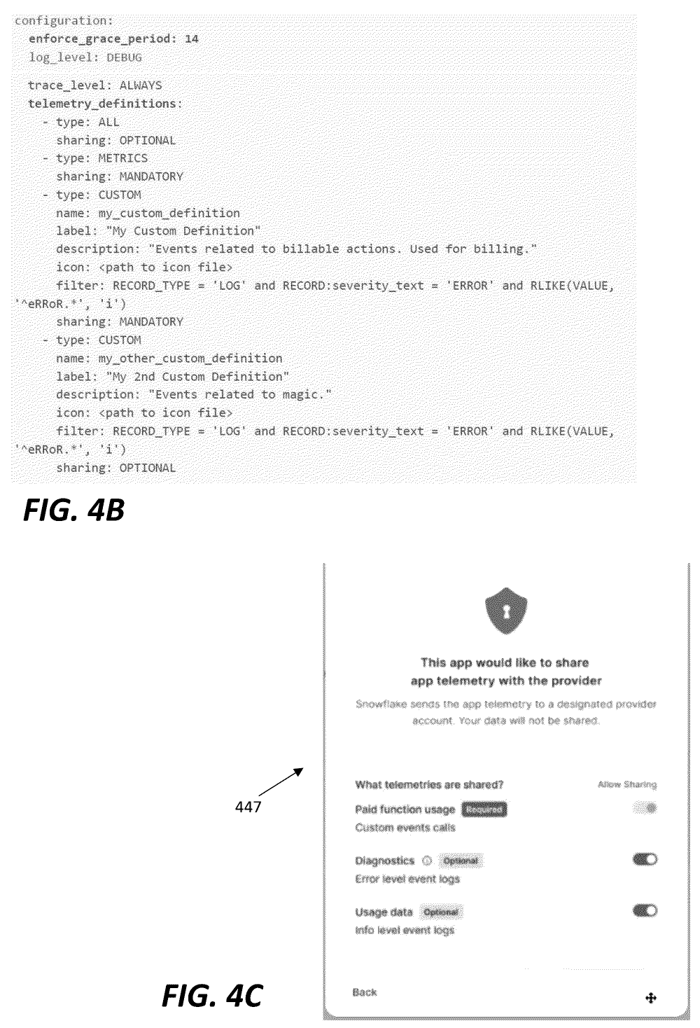

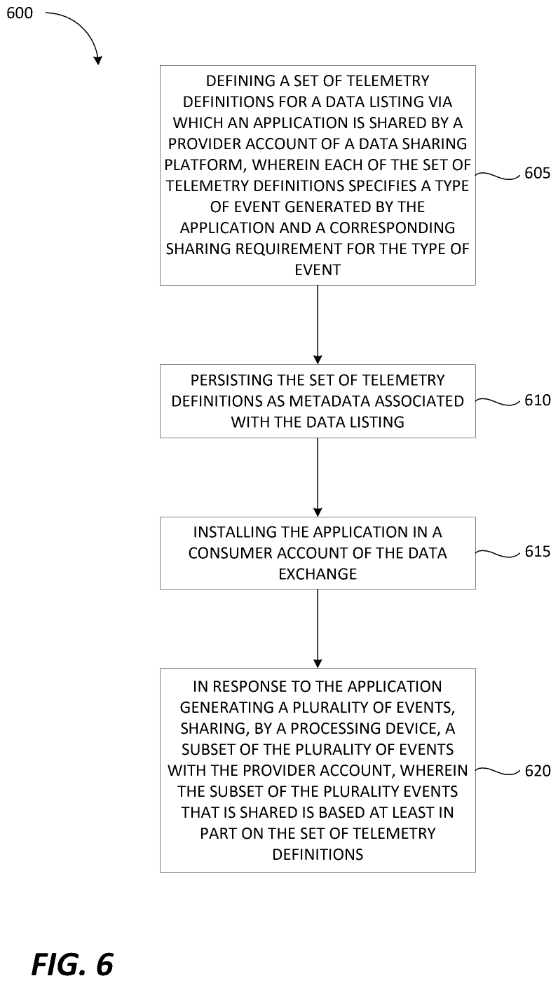

Note that some listings 202 may be discoverable by users without further authentication or access permissions whereas actual accesses are only permitted after a subsequent authentication step (see discussion of FIGS. 4 and 6). The access controls 206 may specify that a listing 202 is only discoverable by specific users or classes of users.

Note also that a default function for listings 202 is that the data referenced by the share is not exportable by the consumer. Alternatively, the access controls 206 may specify that this is not permitted. For example, access controls 206 may specify that secure operations (secure joins and secure functions as discussed below) may be performed with respect to the shared data such that viewing and exporting of the shared data is not permitted.

In some embodiments, once a user is authenticated with respect to a listing 202, a reference to that user (e.g., user identifier of the user's account with the virtual warehouse 131) is added to the access controls 206 such that the user will subsequently be able to access the data referenced by the listing 202 without further authentication.

The listing 202 may define one or more filters 208. For example, the filters 208 may define specific identity data 214 (also referred to herein as user identifiers) of users that may view references to the listing 202 when browsing the catalog 220. The filters 208 may define a class of users (users of a certain profession, users associated with a particular company or organization, users within a particular geographical area or country) that may view references to the listing 202 when browsing the catalog 220. In this manner, a private exchange may be implemented by the exchange manager 124 using the same components. In some embodiments, an excluded user that is excluded from accessing a listing 202 i.e., adding the listing 202 to the consumed shares 156 of the excluded user, may still be permitted to view a representation of the listing when browsing the catalog 220 and may further be permitted to request access to the listing 202 as discussed below. Requests to access a listing by such excluded users and other users may be listed in an interface presented to the provider of the listing 202. The provider of the listing 202 may then view demand for access to the listing and choose to expand the filters 208 to permit access to excluded users or classes of excluded users (e.g., users in excluded geographic regions or countries).

Filters 208 may further define what data may be viewed by a user. In particular, filters 208 may indicate that a user that selects a listing 202 to add to the consumed shares 156 of the user is permitted to access the data referenced by the listing but only a filtered version that only includes data associated with the identity data 214 of that user, associated with that user's organization, or specific to some other classification of the user. In some embodiments, a private exchange is by invitation: users invited by a provider to view listings 202 of a private exchange are enabled to do by the exchange manager 124 upon communicating acceptance of an invitation received from the provider.

In some embodiments, a listing 202 may be addressed to a single user. Accordingly, a reference to the listing 202 may be added to a set of “pending shares” that is viewable by the user. The listing 202 may then be added to a group of shares of the user upon the user communicating approval to the exchange manager 124.

The listing 202 may further include usage data 210. For example, the cloud computing service 112 may implement a credit system in which credits are purchased by a user and are consumed each time a user runs a query, stores data, or uses other services implemented by the cloud computing service 112. Accordingly, usage data 210 may record an amount of credits consumed by accessing the shared data. Usage data 210 may include other data such as a number of queries, a number of aggregations of each type of a plurality of types performed against the shared data, or other usage statistics. In some embodiments, usage data for a listing 202 or multiple listings 202 of a user is provided to the user in the form of a shared database, i.e. a reference to a database including the usage data is added by the exchange manager 124 to the consumed shares 156 of the user.

The listing 202 may also include a heat map 211, which may represent the geographical locations in which users have clicked on that particular listing. The cloud computing service 112 may use the heat map to make replication decisions or other decisions with the listing. For example, a data exchange may display a listing that contains weather data for Georgia, USA. The heat map 211 may indicate that many users in California are selecting the listing to learn more about the weather in Georgia. In view of this information, the cloud computing service 112 may replicate the listing and make it available in a database whose servers are physically located in the western United States, so that consumers in California may have access to the data. In some embodiments, an entity may store its data on servers located in the western United States. A particular listing may be very popular to consumers. The cloud computing service 112 may replicate that data and store it in servers located in the eastern United States, so that consumers in the Midwest and on the East Coast may also have access to that data.

The listing 202 may also include one or more tags 213. The tags 213 may facilitate simpler sharing of data contained in one or more listings. As an example, a large company may have a human resources (HR) listing containing HR data for its internal employees on a data exchange. The HR data may contain ten types of HR data (e.g., employee number, selected health insurance, current retirement plan, job title, etc.). The HR listing may be accessible to 100 people in the company (e.g., everyone in the HR department). Management of the HR department may wish to add an eleventh type of HR data (e.g., an employee stock option plan). Instead of manually adding this to the HR listing and granting each of the 100 people access to this new data, management may simply apply an HR tag to the new data set and that can be used to categorize the data as HR data, list it along with the HR listing, and grant access to the 100 people to view the new data set.

The listing 202 may also include version metadata 215. Version metadata 215 may provide a way to track how the datasets are changed. This may assist in ensuring that the data that is being viewed by one entity is not changed prematurely. For example, if a company has an original data set and then releases an updated version of that data set, the updates could interfere with another user's processing of that data set, because the update could have different formatting, new columns, and other changes that may be incompatible with the current processing mechanism of the recipient user. To remedy this, the cloud computing service 112 may track version updates using version metadata 215. The cloud computing service 112 may ensure that each data consumer accesses the same version of the data until they accept an updated version that will not interfere with current processing of the data set.

The exchange data 200 may further include user records 212. The user record 212 may include data identifying the user associated with the user record 212, e.g. an identifier (e.g., warehouse identifier) of a user having user data 151 in service database 158 and managed by the virtual warehouse 131.

The user record 212 may list shares associated with the user, e.g., listings 154 (shares 154) created by the user. The user record 212 may list shares consumed by the user i.e., consumed shares 156 which may be listings 202 created by another user and that have been associated to the account of the user according to the methods described herein. For example, a listing 202 may have an identifier that will be used to reference it in the shares or consumed shares 156 of a user record 212.

The listing 202 may also include metadata 204 describing the shared data. The metadata 204 may include some or all of the following information: an identifier of the provider of the shared data, a URL associated with the provider, a name of the share, a name of tables, a category to which the shared data belongs, an update frequency of the shared data, a catalog of the tables, a number of columns and a number of rows in each table, as well as name for the columns. The metadata 204 may also include examples to aid a user in using the data. Such examples may include sample tables that include a sample of rows and columns of an example table, example queries that may be run against the tables, example views of an example table, example visualizations (e.g., graphs, dashboards) based on a table's data. Other information included in the metadata 204 may be metadata for use by business intelligence tools, text description of data contained in the table, keywords associated with the table to facilitate searching, a link (e.g., URL) to documentation related to the shared data, and a refresh interval indicating how frequently the shared data is updated along with the date the data was last updated.

The metadata 204 may further include category information indicating a type of the data/service (e.g., location, weather), industry information indicating who uses the data/service (e.g., retail, life sciences), and use case information that indicates how the data/service is used (e.g., supply chain optimization, or risk analysis). For instance, retail consumers may use weather data for supply chain optimization. A use case may refer to a problem that a consumer is solving (i.e., an objective of the consumer) such as supply chain optimization. A use case may be specific to a particular industry, or can apply to multiple industries. Any given data listing (i.e., dataset) can help solve one or more use cases, and hence may be applicable to multiple use cases.

The exchange data 200 may further include a catalog 220. The catalog 220 may include a listing of all available listings 202 and may include an index of data from the metadata 204 to facilitate browsing and searching according to the methods described herein. In some embodiments, listings 202 are stored in the catalog in the form of JavaScript Object Notation (JSON) objects.

Note that where there are multiple instances of the virtual warehouse 131 on different cloud computing platforms, the catalog 220 of one instance of the virtual warehouse 131 may store listings or references to listings from other instances on one or more other cloud computing platforms 110. Accordingly, each listing 202 may be globally unique (e.g., be assigned a globally unique identifier across all of the instances of the virtual warehouse 131). For example, the instances of the virtual warehouses 131 may synchronize their copies of the catalog 220 such that each copy indicates the listings 202 available from all instances of the virtual warehouse 131. In some instances, a provider of a listing 202 may specify that it is to be available on only specified one or more computing platforms 110.

In some embodiments, the catalog 220 is made available on the Internet such that it is searchable by a search engine such as the Bing™ search engine or the Google search engine. The catalog may be subject to a search engine optimization (SEO) algorithm to promote its visibility. Potential consumers may therefore browse the catalog 220 from any web browser. The exchange manager 124 may expose uniform resource locators (URLs) linked to each listing 202. This URL may be searchable and can be shared outside of any interface implemented by the exchange manager 124. For example, the provider of a listing 202 may publish the URLs for its listings 202 in order to promote usage of its listing 202 and its brand.

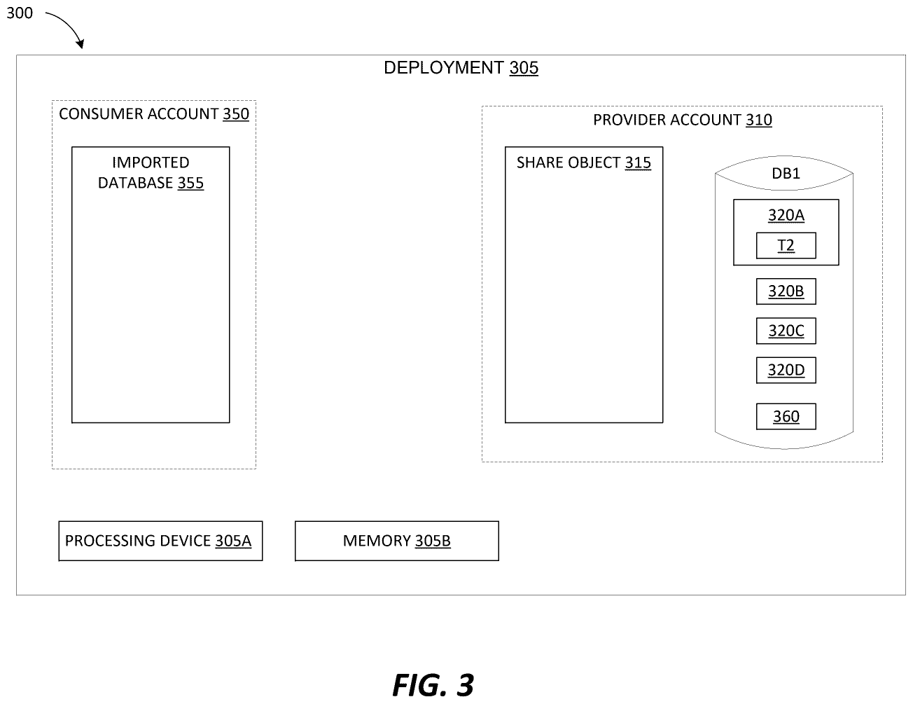

FIG. 3 illustrates a cloud environment 300 comprising a cloud deployment 305, which may comprise a similar architecture to cloud computing service 112 (illustrated in FIG. 1A) and may be a deployment of a data exchange or data marketplace. Although illustrated with a single cloud deployment, the cloud environment 300 may have multiple cloud deployments which may be physically located in separate remote geographical regions but may all be deployments of a single data exchange or data marketplace. Although embodiments of the present disclosure are described with respect to a data exchange, this is for example purpose only and the embodiments of the present disclosure may be implemented in any appropriate enterprise database system or data sharing platform where data may be shared among users of the system/platform.

The cloud deployment 305 may include hardware such as processing device 305A (e.g., processors, central processing units (CPUs), memory 305B (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The cloud deployment 305 may comprise any suitable type of computing device or machine that has a programmable processor including, for example, server computers, desktop computers, laptop computers, tablet computers, smartphones, set-top boxes, etc. In some examples, the cloud deployment 305 may comprise a single machine or may include multiple interconnected machines (e.g., multiple servers configured in a cluster).

Databases and schemas may be used to organize data stored in the cloud deployment 305 and each database may belong to a single account within the cloud deployment 305. Each database may be thought of as a container having a classic folder hierarchy within it. Each database may be a logical grouping of schemas and a schema may be a logical grouping of database objects (tables, views, etc.). Each schema may belong to a single database. Together, a database and a schema may comprise a namespace. When performing any operations on objects within a database, the namespace is inferred from the current database and the schema that is in use for the session. If a database and schema are not in use for the session, the namespace must be explicitly specified when performing any operations on the objects. As shown in FIG. 3, the cloud deployment 305 may include a provider account 310 including database DB1 having schemas 320A-320D.

FIG. 3 also illustrates share-based access to objects in the provider account 310. The provider account 310 may create a share object 315, which includes grants to database DB1 and schema 320A, as well as a grant to a table T2 located in schema 320A. The grants on database DB1 and schema 320A may be usage grants and the grant on table T2 may be a select grant. In this case, the table T2 in schema 320A in database DB1 would be shared read-only. The share object 315 may contain a list of references (not shown) to various consumer accounts, including the consumer account 350.

After the share object 315 is created, it may be imported or referenced by consumer account 350 (which has been listed in the share object 315). Consumer account 350 may run a command to list all available share objects for importing. Only if the share object 315 was created with a reference to the consumer account 350, then the consumer account 350 reveals the share object using the command to list all share objects and subsequently import it. In one embodiment, references to a share object in another account are always qualified by account name. For example, consumer account 350 would reference a share object SH1 in provider account A1 with the example qualified name “A1.SH1.” Upon the share object 315 being imported to consumer account 350 (shown as imported database 355), an administrator role (e.g., an account level role) of the consumer account 350 may be given a usage grant to the imported database 355. In this way, a user in account 350 with the administrator role 350A may access data from DB1 that is explicitly shared/included in the share object 315.

Similar to the way that data can be shared from a provider account to a consumer account, applications can also be shared from a provider account to a consumer account. As with sharing of data, sharing of a native application (hereinafter referred to as an application) may be performed using a shared container.

FIG. 4A illustrates an example native application sharing process taking place within the deployment 305. It should be noted that embodiments of the present disclosure may be used with any native application sharing process and the process illustrated in FIG. 4A is not limiting. Upon creating the database DB1 and the schema 320A, the provider account 310 may generate an application package 410 and store it in the schema 320A. The provider account 310 may define the application package 410 with the necessary functionality to install the application (including any objects and procedures required by the application) in the consumer account 350. The native applications framework 475 may enable the provider account 310 to indicate that the application package 410 will automatically be invoked with no arguments when a consumer with whom the application package 410 has been shared requests installation of the application. The provider account 310 may create an application share object (not shown) and attach the application package 410 to the application share object. The provider account 310 may then grant the necessary privileges to the application share object including usage on the database DB1, usage on the schema 320A, and usage on the application package 410.

When the consumer account 350 runs a command to see the available listings, they may see a listing corresponding to the application share object and may run a command to create an instance of application 426 from the listing (e.g., CREATE APPLICATION <name> FROM LISTING <listing name>). In response to execution of the command, the native applications framework 475 may automatically trigger execution of script files 428 of the application package 410, which may create objects (e.g., credentials, API integration, and a warehouse) as well as tasks/procedures corresponding to the functionality of the application instance 426 in the consumer account 350 as discussed in further detail herein. The consumer account 350 may also grant privileges necessary for the application instance 426 to run (some privileges are granted on objects managed and owned by the consumer account 350) including usage on secrets, usage on the API Integration, usage on the warehouse, and privileges granted to the application instance 426 if it needs to access objects of the consumer account 350 or execute procedures in the consumer account 350. Once installed, the application instance 426 may perform various functions in the consumer account 350 as long as the consumer account 350 has authorized it. The application instance 426 can act as an agent, and take any action that any role on the consumer account 350 could take such as e.g., set up a task pipeline, set up data ingestion (e.g., via Snowpipe™ ingestion), or any other defined functionality of the application instance 426. The application instance 426 may act on behalf of the consumer account 350 and execute procedures in a programmatic way.

As shown in FIG. 4A, the application package 410 is used by the provider account 310 to create a database application that can be provided to the consumer account 350. Once properly instantiated, such as application instance 426, the application can be executed by the consumer account 350 and access content off the application package 410 that is shared to application instance 426 including one or more objects, such as objects 440, in a secure manner.

The application package 410 comprises one or more application artifacts 436 in the form of executable objects such as, but not limited to script files 428, python files 432, and jar files 431, that are stored in an application artifacts datastore such as a named filesystem scoped to the artifact schema 321 associated with the provider account 310. In some examples, the datastore for the application artifacts 436 includes directory data 456 accessed by the consumer application instance 426 at run time in the consumer account 454 for storage of the executable files once the application instance 426 has been instantiated. In some examples, the application artifacts 436 are defined in the artifact schema 321, In some examples, the artifact schema 321 contains script files 428 that are executed within the application instance 426 to define the application. In some examples, an application may have none or more application package versions that are containers for the artifact schema 321 and the named storage location 434.

The application package 410 further comprises shared content 438 comprising one or more data objects, such as objects 440, that constitute objects shared to the application instance 426 that are accessed and/or operated on by the application instance 426 during execution of executable objects of the versioned schema 464 of the application instance 426 such as, but not limited to, functions 418 and procedures 420. In some examples, the application package 410 includes shared content comprising one or more schemas containing objects such as, but not limited to, tables, views, and the like. In sore examples, the shared content 438 is accessed by the application instance 426 based on a set of security protocols.

The application instance 426 comprises a set of versioned objects 424 that are created during the instantiation of the application instance 426. The versioned objects 424 include objects 416 of a versioned schema 464 that are defined by the application artifacts 436, In some examples, the objects 416 comprise one or more functions 418, one or more procedures 420, one or more tables 422, and the like.

In some examples, when the application instance 426 is being upgraded to a new version, the setup script modifies existing objects of the application instance 426. In some examples, the application artifacts 436 are stored as part of the version definition of the application package 410, and are stored as e.g., java jars, python files, and the like but are not installed within the application instance 426. The application artifacts 436 are referred to from objects 416 that are installed by the installation script. For example, an object of objects 416 may be a java stored procedure that refers to a jar file that is located in the versioned schema 464, but these objects are directly accessed, at run time, in the provider package when the procedure is executed.

In some examples, when a version of the application package 410 is created, the provider account 310 specifies a location of the root directory in a named storage location for that application version, and a manifest file 470 is provided in that location. The native applications framework 475 configures one or more components of the application instance 426 based on the manifest file 470. The manifest file 470 includes properties related to the application version of the application package 410 such as a name, an application version value, a display name and the like. The manifest file 470 also includes information about runtime behavior of the application instance 426 such as, but not limited to, execution of extension code, connections to external services and the Uniform Resource Locations (URLs) of those services, running of background tasks and the like.

The events generated by an application instance 426 may be organized into an event table, which includes a row for each event, a first column to indicate a type of each event (e.g., log, metric, span, or span event) and a second column to provide information regarding each event. The information regarding each event may not be stored exclusively in the second column, and the event table may include any appropriate number of columns over which the information regarding each event may be stored. When the first column for an event indicates a log event type, the corresponding entry in the second column may include severity text indicating information about the log event such as the severity of the log event. Example severity text may include Trace, Debug, Info, Warning, Error, and Fatal. Based on the severity text, a log event may be classified as e.g., a usage log, a debug log or a query audit log. In addition, the severity text may indicate a scope of the log event such as a class name for the log event. When the event type is span or span event, the second column may include e.g., a name of the span or span event. It should be noted that a span may represent an individual execution of a function or procedure while a span event may be an event record attached to a particular span execution.

The provider account 310 may also define a set of telemetry definitions 471 for the application package 410, where each telemetry definition 471 may indicate a telemetry type and a sharing requirement (e.g., “optional” or “mandatory”) for the telemetry type. Each of the set of telemetry definitions 471 may be used to filter the events that are shared with the provider account 310, as discussed in further detail herein. The provider account 310 may define each of the set of telemetry definitions 471 in the manifest file 470 of the application package 410. In some embodiments, the provider account 310 may define the set of telemetry definitions 471 in the manifest file 470 for each application version of the application package 410. Each telemetry definition 471 may indicate one of the following example predefined telemetry types (other telemetry types are contemplated within the scope of this disclosure):
All: The “All” telemetry type includes all event types.
Errors_and_Warnings: The “Errors_and_Warnings” telemetry type includes “LOG” event types that have event severity text indicating “Fatal,” “Error” or “Warning.”
Metrics: The “Metrics” telemetry type includes “METRIC,” “SPAN” and “SPAN EVENT” event types.
Usage Logs: The “Usage Logs” telemetry type includes “LOG” event types that have event severity text indicating “Info.”
Debug_Logs: The “Debug_Logs” telemetry type includes “SPAN” and “SPAN EVENT” event types as well as or “LOG” event types that have event severity text indicating (“Debug” or “Trace”).
Query_Audit_Logs: The “Query_Audit_Logs” telemetry type includes “LOG” event types that have event severity text indicating “Info” and a particular class (e.g., “scope=snow.audit_log”).

The provider account 310 may also define a custom telemetry type. The provider account 310 may use any appropriate expression language such as SQL or CEL to define any custom telemetry type. The native applications framework 475 may provide a custom telemetry template for defining a custom telemetry type. The custom telemetry template may allow the provider account 310 to define different attributes of a custom telemetry type including e.g., a filter, a label, a description, and an icon among other attributes. A filter may comprise an expression language predicate string defining the custom telemetry type. A label may comprise a string identifying the custom telemetry type and a description may comprise a string describing the custom telemetry type. An icon may indicate a path to file, which must meet certain criteria (e.g., file type, size, etc.).

FIG. 4B illustrates the set of telemetry definitions 471. As shown in FIG. 4B, a first telemetry definition 471 may indicate the “All” telemetry type and that the sharing requirement for the “All” telemetry type is “optional.” A second telemetry definition 471 may indicate the “Metrics” telemetry type and that the sharing requirement for the “Metrics” telemetry type is “mandatory.” A third telemetry definition 471 may indicate a “Custom” telemetry type, having a name “my_custom_definition,” a label of “My Custom Definition,” and a description of “Events related to billable actions. Used for billing.” The filter of the custom telemetry type may be e.g., “EVENT_TYPE=‘LOG’ and EVENT:severity_text=‘ERROR’ and RLIKE(VALUE, ‘\hat{ }eRRoR.*’ ‘i’).” This example includes log event that have a severity text of “error” or a severity text sufficiently similar to “error.” In the example of FIG. 4B, the provider account 310 may set the sharing requirement for the “Custom” telemetry type to “mandatory.”

The set of telemetry definitions 471 may be parsed and validated by the native applications framework 475 during application package version creation. When an application package is attached to a listing, version metadata for versions/patches that are pointed to by release directives are populated in a data persistence object (DPO) of the data exchange listing corresponding to the application. The set of telemetry definitions 471 may be populated as part of the version metadata.

When the consumer account 350 runs a command to see the available shares (listings), they may be provided with a list of data listings available to them, where each data listing includes metadata including any telemetry definitions (if the listing is for an application) that have been defined for the application. The consumer account 350 may see the listing corresponding to the application share object to which the application package 410 is attached and may run a command to create an instance of application 426 from the data listing.

When the consumer account 350 installs the application 445 (e.g., using a “create application” command), no event sharing is enabled yet. Instead, the native applications framework 475 may cause a user interface 447 (e.g., a dialog window as shown in FIG. 4C) to be displayed to the consumer, the dialog window prompting the consumer to accept sharing of telemetry data back to the provider account 310 based on the telemetry definitions included in the data listing. In some embodiments, the dialog window will have a row for each of the set of telemetry definitions, with a toggle button per telemetry definition, as shown in FIG. 4C. For each optional telemetry definition (i.e., a telemetry definition that specifies that sharing is optional for the corresponding event type), the consumer may use the toggle button to select whether they will share events of the corresponding type. In some embodiments, for mandatory telemetry definitions (i.e., a telemetry definition that specifies that sharing is mandatory for the corresponding event type), the consumer may use the toggle button to select whether they will share events of the corresponding type. Mandatory telemetry definitions are accepted by the consumer once and thereafter acceptance cannot be revoked b the consumer. Until the consumer accepts each mandatory telemetry definition, sharing of events generated by the application 426 does not occur. The provider can query the acceptance status of each telemetry definition and if any mandatory telemetry definitions have not been accepted, they may programmatically cripple the application 426 if they choose. In other embodiments, the toggle button corresponding to mandatory telemetry definitions will be toggled “on” and be disabled so that the consumer cannot disable sharing of events governed by mandatory telemetry definitions. If there are no mandatory telemetry definitions in the set of telemetry definitions 471, the consumer does not have to agree to share any events.

In some embodiments, if the set of telemetry definitions 471 has any mandatory telemetry definitions, instead of including a toggle button in the dialog window for each mandatory telemetry definition, the “create application” command will fail unless it specifies that sharing of telemetry data specified by mandatory telemetry definitions is accepted. As discussed hereinabove, mandatory telemetry definitions are accepted by the consume once and thereafter acceptance cannot be revoked by the consumer.

In some embodiments, the dialog window may include “Accept” and “Cancel”(not shown in FIG. 4C) buttons at the bottom of the window. Once the selections for each optional telemetry definition are made, a consumer clicking the “Accept” button will send the event sharing configuration to the application 445 as accepted. The API for the application 445 will validate the sharing configuration against the set of telemetry definitions 471 from the manifest 470.

In some embodiments, the consumer may be given a grace period e.g., 14 days to agree to share events on the basis specified by the set of telemetry definitions 471. During this time, the consumer may use the application without sharing any or certain event types. If the consumer has not agreed to share events on the basis specified by the set of telemetry definitions 471 by end of the grace period, the native applications framework 475 may disable the application 445 until the consumer agrees to share events on the basis specified by the set of telemetry definitions 471 or the consumer uninstalls the application 445. In some embodiments, the grace period duration may be specified as part of the set of telemetry definitions 471.

When transitioning to a new version of the application 426, there may be modifications to the set of telemetry definitions 471 (e.g., additions, deletions, modifications to individual telemetry definitions). If a telemetry definition that existed in the previous version of the application 426 has been deleted in the new version, the native applications framework 475 may revoke any acceptance provided by the consumer to share the type of telemetry data specified by the deleted telemetry definition. In this way, if the deleted telemetry definition is later added to a subsequent version of the application 426, acceptance must be obtained again from the consumer (as discussed above) when transitioning to the subsequent version of the application 426. If a new: telemetry definition is added to the set of telemetry definitions 471 in the new version, acceptance must be obtained from the consumer (as discussed above) when transitioning to the new version of the application 426.

If a telemetry definition that existed in the previous version of the application 426 has been modified in the new version of the application 426, the native application framework 475 may treat the modified telemetry definition as if it was previously deleted and added back into the new version of the application. Thus, the native application framework 475 may obtain acceptance from the consumer (as discussed above) again when transitioning to the new version of the application 426.

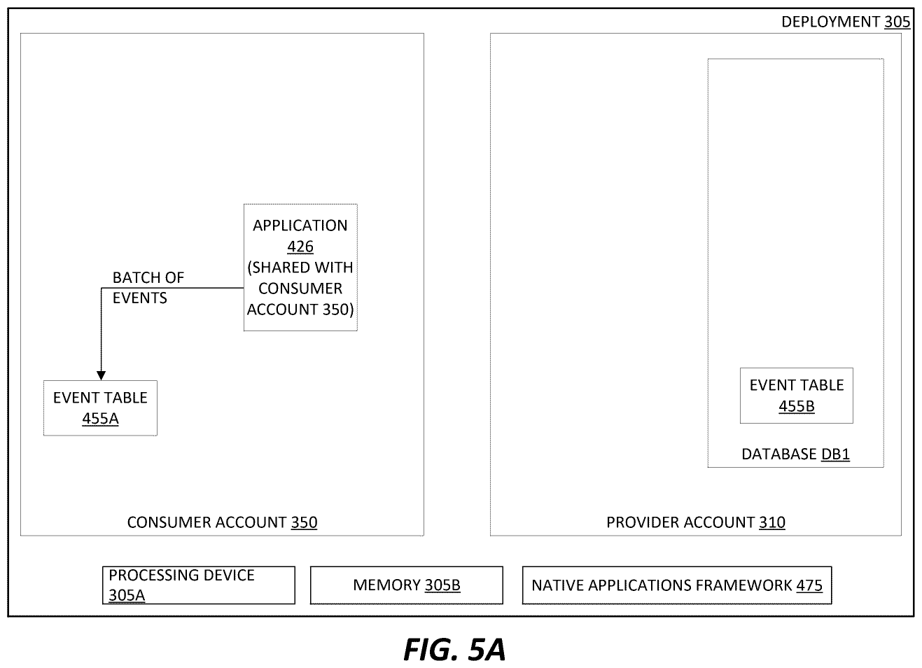

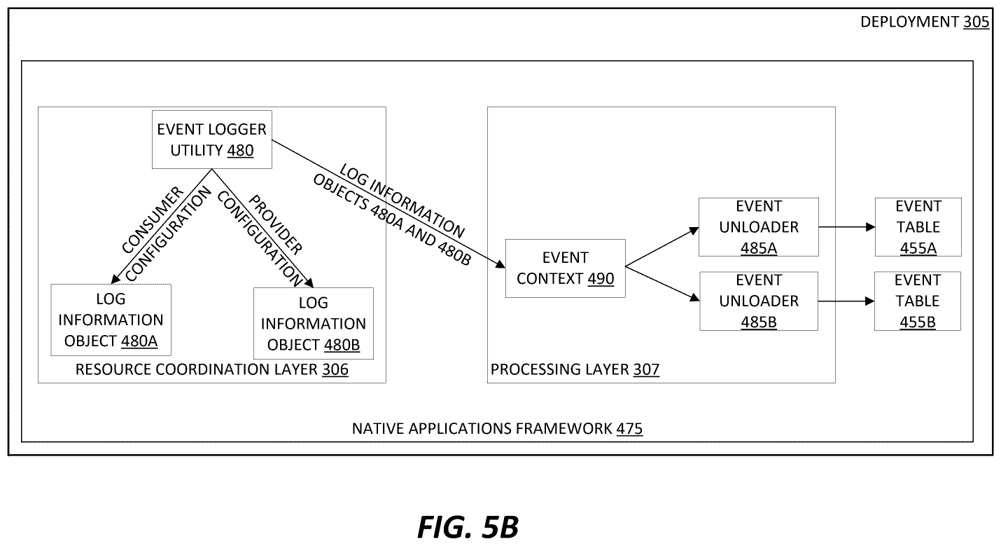

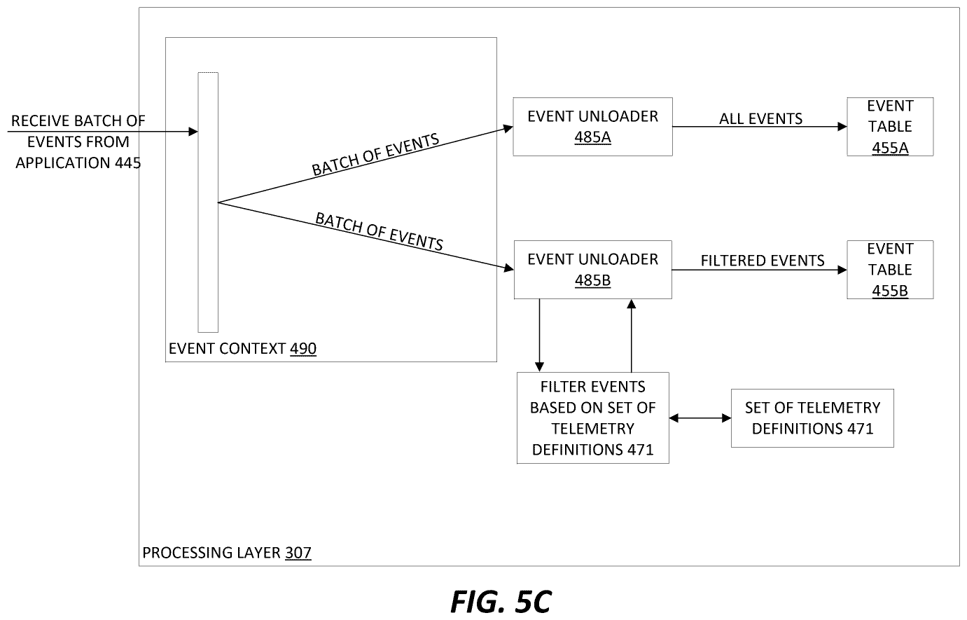

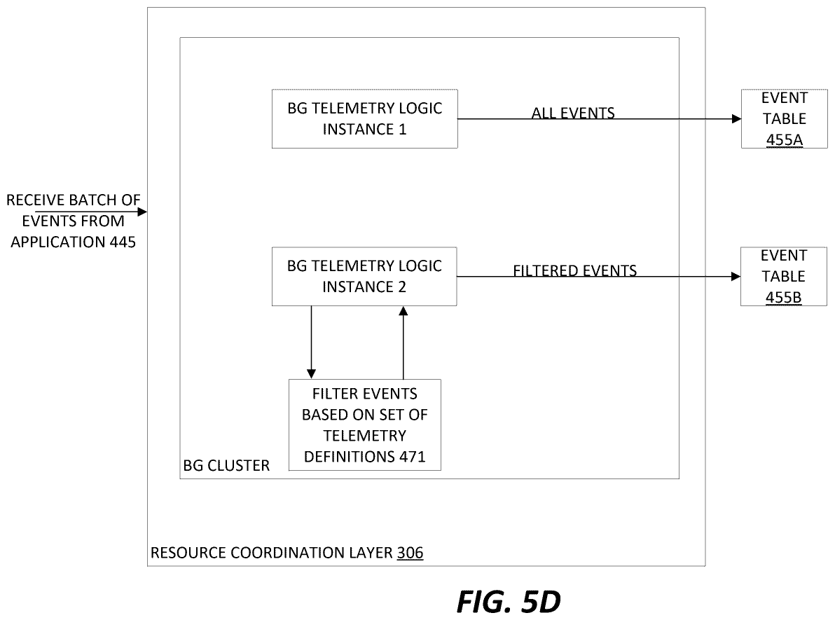

As discussed hereinabove, events generated by shared applications has a variety of uses for both providers and consumers. The native applications framework 475 may provide functionality to log events generated by shared applications being executed by a consumer and provide such events to the consumer and the provider as discussed herein. FIG. 5A illustrates the deployment 305 with the consumer account 350 executing application 426, which the provider account 310 has shared with the consumer account 350 as discussed above with respect to FIG. 4A. The native applications framework 475 may monitor execution of the application 426 to obtain events including errors and warnings, metrics, usage logs, debug logs, and query audit logs, and provide these events to the consumer account 350. More specifically, the native applications framework 475 may facilitate the ingestion and storage of events generated by the application 426 into an event table 455A of the consumer account 350 and certain events generated by the application 426 (based on the set of telemetry definitions 471) into the event table 455B of the provider account 310 whenever the consumer account 350 calls the application 426. Each account (consumer or provider) of the deployment 305 may include an event table (e.g., event table 455A of the consumer account and event table 455B of the provider account) which may be used to store events generated by applications they are sharing or consuming.

FIG. 5B illustrates a detailed view of the traditional logging functionality of the native applications framework 475. The native applications framework 475 may include a logger utility 480 that may configure targets (e.g., consumer event table 455A) into which events associated with execution of the application 445 are to be loaded. The functionality of the logger utility 480 may be implemented by the resource coordination layer 306 of the deployment 305, which may be a collection of services that process user requests, including login, metadata management, query parsing/optimization, and query coordination/dispatch services. Referring simultaneously to FIG. 5A, to support ingesting events into the consumer event table 455A and the provider event table 455B, the logger utility 480 may create a consumer configuration and a provider configuration and may add the consumer configuration and the provider configuration to their own log information objects 480A and 480B respectively. Each log information object 480A and 480B may contain all the information required to send events to an individual event table including e.g., task pipe ID and staging file name. The information required to send the events to an event table may also be referred to herein as a “configuration.” Thus, for example, information required to send events to the consumer event table 455A may be referred to as a consumer configuration while information required to send events to a provider event table 455B may be referred to as a provider configuration.

The logger utility 480 may then provide the log information objects 480A and 480B to processing layer 307, which may perform query execution as well as execution of other functions, and may comprise multiple virtual warehouses, each of which is a compute cluster (e.g., a massively parallel processing compute cluster) composed of multiple compute nodes. The processing layer 307 of the deployment 305 may include an event context 490 which may use the consumer configuration to create an event unloader 485A associated with the consumer event table 455A and may use the provider configuration to create an event unloader 485B associated with the provider event table 455B. Each event unloader 485 is ultimately responsible for writing events generated by the application 445 to a respective event table 455.

Referring now to FIG. 5C, the event context 490 may receive a batch of events generated by the application 445 and provide the batch of events to the event unloader 485A and the event unloader 485B. The event unloader 485A may write all of the batch of events generated by the application 445 into the consumer event table 455A. The processing layer 307 may filter the batch of events received by the event unloader 485B using the set of telemetry definitions 471 and the consumer selections received via the user interface 447 to filter out all events from the batch of events that the consumer has and opted not to share with the provider. In some embodiments, this filtering may be performed by the event unloader 485B itself. The event unloader 485B may then write those events that are not filtered out to the provider event table 455B. The event unloader 485B may treat the set of telemetry definitions 471 as a kind of routing policy that decides whether an event should be routed to the provider's event table 455B or not (in conjunction with the consumer selections received via the user interface 447). It should be noted that the processing layer 307 may perform the filtering at any appropriate time including e.g., before the batch of events is provided to the event unloader 485B (e.g., when the event unloaders 485A and 485B are being created).

In some embodiments, the filtering may be performed by the resource coordination layer 306. The resource coordination layer 306 may be divided into two categories: foreground (FG) and background (BG) instances. While FG instances are responsible for handling customer queries (including compilation and query lifecycle management), BG instances are responsible for running a variety of background services including instance health management, updating load balancer configurations, and orchestration tasks themselves. BG instances may be partitioned into dedicated clusters for provisioning services, core background services and compute tasks, etc. As shown in FIG. 5D, a BG cluster may include BG telemetry logic instances 1 and 2, where each BG telemetry logic instance may perform any filtering as necessary and provide the events to a respective event table. In the example of FIG. 5D, the BG telemetry logic instance 1 may write all of the batch of events generated by the application 445 into the consumer event table 455A. The BG telemetry logic instance 2 may filter the batch of events generated by application 445 using the set of telemetry definitions 471 to filter out all events from the batch of events that the consumer has and opted not to share with the provider. The BG telemetry logic instance 2 may then write those events that are not filtered out to the provider event table 455B.

FIG. 6 is a flow diagram of a method 600 for selectively sharing with a provider account of a data exchange, events generated by an application shared by the provider account via the data exchange, in accordance with some embodiments of the present disclosure. Method 600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 600 may be performed by a processing device 305A of cloud deployment 305 (illustrated in FIGS. 4A and 5A).

Referring also to FIGS. 4A-4C, at block 605 the provider account 310 may define a set of telemetry definitions 471 for the application package 410, where each telemetry definition 471 may indicate a telemetry type and a sharing requirement (e.g., “optional” or “mandatory”) for the telemetry type. Each of the set of telemetry definitions 471 may be used to filter the events that are shared with the provider account 310, as discussed in further detail herein. The provider account 310 may use any appropriate expression language such as SQL or CEL to define each of the set of telemetry definitions 471, and may define each of the set of telemetry definitions 471 in the manifest file 470 of the application package 410. In some embodiments, the provider account 310 may define the set of telemetry definitions 471 in the manifest file 470 for each application version of the application package 410. Each telemetry definition 471 may indicate one of the following example predefined telemetry types:
All: The “All” telemetry type includes all event types.
Errors_and_Warnings: The “Errors_and_Warnings” telemetry type includes “LOG” event types that have event severity text indicating “Fatal,” “Error” or “Warning.”
Metrics: The “Metrics” telemetry type includes “METRIC,” “SPAN” and “SPAN EVENT” event types.
Usage Logs: The “Usage Logs” telemetry type includes “LOG” event types that have event severity text indicating “Info.”
Debug_Logs: The “Debug_Logs” telemetry type includes “SPAN” and “SPAN EVENT” event types as well as or “LOG” event types that have event severity text indicating (“Debug” or “Trace”).
Query_Audit_Logs: The “Query_Audit_Logs” telemetry type includes “LOG” event types that have event severity text indicating “Info” and a particular class (e.g., “scope=snow.audit_log”).

The provider account 310 may also define a custom telemetry type. The provider account 310 may use any appropriate expression language such as SQL or CEL to define any custom telemetry type. The native applications framework 475 may provide a custom telemetry template for defining a custom telemetry type. The custom telemetry template may allow the provider account 310 to define different attributes of a custom telemetry type including e.g., a filter, a label, a description, and an icon among other attributes. A filter may comprise an expression language predicate string defining the custom telemetry type. A label may comprise a string identifying the custom telemetry type and a description may comprise a string describing the custom telemetry type. An icon may indicate a path to file, which must meet certain criteria (e.g., file type, size, etc.).

FIG. 4B illustrates the set of telemetry definitions 471. As shown in FIG. 4B, a first telemetry definition 471 may indicate the “All” telemetry type and that the sharing requirement for the “All” telemetry type is “optional.” A second telemetry definition 471 may indicate the “Metrics” telemetry type and that the sharing requirement for the “Metrics” telemetry type is “mandatory.” A third telemetry definition 471 may indicate a “Custom” telemetry type, having a name “my_custom_definition,” a label of “My Custom Definition,” and a description of “Events related to billable actions. Used for billing.” The filter of the custom telemetry type may be e.g., “EVENT_TYPE=‘LOG’ and EVENT:severity_text=‘ERROR’ and RLIKE(VALUE, ‘\hat{ }eRRoR.*’, ‘i’).” In the example of FIG. 4B, the provider account 310 may set the sharing requirement for the “Custom” telemetry type to “mandatory.”

The set of telemetry definitions 471 may be parsed and validated by the native applications framework 475 during application package version creation. When an application package is attached to a listing, version metadata for versions/patches that are pointed to by release directives are populated in a data persistence object (DPO) of the data exchange listing corresponding to the application. At block 610, the set of telemetry definitions 471 may be populated as part of the version metadata.

When the consumer account 350 runs a command to see the available shares (listings), they may be provided with a list of data listings available to them, where each data listing includes metadata including any telemetry definitions (if the listing is for an application) that have been defined for the application. The consumer account 350 may see the listing corresponding to the application share object to which the application package 410 has been attached, and may run a command to create an instance of the application 426 in the consumer account 350.

At block 615, the consumer account 350 installs the application 445, however at this point no event sharing is enabled yet. Instead, the native applications framework 475 may cause a dialog window to be displayed to the consumer, the dialog window prompting the consumer to accept sharing of telemetry data back to the provider account 310 based on the telemetry definitions included in the data listing. In some embodiments, the dialog window will have a row for each of the set of telemetry definitions, with a toggle button per telemetry definition, as shown in FIG. 4C. For each optional telemetry definition (i.e., a telemetry definition that specifies that sharing is optional for the corresponding event type), the consumer may use the toggle button to select whether they will share events of the corresponding type. In some embodiments, for mandatory telemetry definitions (i.e., a telemetry definition that specifies that sharing is mandatory for the corresponding event type), the consumer may use the toggle button to select whether they will share events of the corresponding type. As discussed hereinabove, mandatory telemetry definitions are accepted by the consumer once and thereafter acceptance cannot be revoked by the consumer. Until the consumer accepts each mandatory telemetry definition, sharing of events generated by the application 426 does not occur. The provider can query the acceptance status of each telemetry definition and if any mandatory telemetry definitions have not been accepted, they may programmatically cripple the application 426 if they choose. In other embodiments, the toggle button corresponding to mandatory telemetry definitions will be toggled “on” and be disabled so that the consumer cannot disable sharing of events governed by mandatory telemetry definitions. If there are no mandatory telemetry definitions in the set of telemetry definitions 471, the consumer does not have to agree to share any events.

In some embodiments, if the set of telemetry definitions 471 has any mandatory telemetry definitions, instead of including a toggle button in the dialog window for each mandatory telemetry definition, the “create application” command will fail unless it specifies that sharing of telemetry data specified by mandatory telemetry definitions is accepted.

In some embodiments, the dialog window may include “Accept” and “Cancel” buttons at the bottom of the window. Once the selections for each optional telemetry definition are made, a consumer clicking the “Accept” button will send the event sharing configuration to the application 445 as accepted. The API for the application 445 will validate the sharing configuration against the set of telemetry definitions 471 from the manifest 470.

In some embodiments, the consumer may be given a grace period e.g., 14 days to agree to share events on the basis specified by the set of telemetry definitions 471. During this time, the consumer may use the application without sharing any or certain event types. If the consumer has not agreed to share events on the basis specified by the set of telemetry definitions 471 by end of the grace period, the native applications framework 475 may disable the application 445 until the consumer agrees to share events on the basis specified by the set of telemetry definitions 471 or the consumer uninstalls the application 445. In some embodiments, the grace period duration may be specified as part of the set of telemetry definitions 471.

When transitioning to a new version of the application 426, there may be modifications to the set of telemetry definitions 471 (e.g., additions, deletions, modifications to individual telemetry definitions). If a telemetry definition that existed in the previous version of the application 426 has been deleted in the new version, the native applications framework 475 may revoke any acceptance provided by the consumer to share the type of telemetry data specified by the deleted telemetry definition. In this way, if the deleted telemetry definition is later added to a subsequent version of the application 426, acceptance must be obtained again from the consumer (as discussed above) when transitioning to the subsequent version of the application 426. If a new telemetry definition is added to the set of telemetry definitions 471 in the new version, acceptance must be obtained from the consumer (as discussed above) when transitioning to the new version of the application 426.

If a telemetry definition that existed in the previous version of the application 426 has been modified in the new version of the application 426, the native application framework 475 may treat the modified telemetry definition as if it was previously deleted and added back into the new version of the application. Thus, the native application framework 475 may obtain acceptance from the consumer (as discussed above) again when transitioning to the new version of the application 426.

Referring now to FIG. 5C, the event context 490 may receive a batch of events generated by the application 445 and provide the batch of events to the event unloader 485A and the event unloader 485B. The event unloader 485A may write all of the batch of events generated by the application 445 into the consumer event table 455A. At block 620 the processing layer 307 may filter the batch of events received by the event unloader 485B using the set of telemetry definitions 471 and the consumer selections received via the to filter out all events from the batch of events that the consumer has and opted not to share with the provider. In some embodiments, this filtering may be performed by the event unloader 485B itself. The event unloader 485B may then write those events that are not filtered out to the provider event table 455B. The event unloader 485A may treat the set of telemetry definitions 471 as a kind of routing policy that decides whether an event should be routed to the provider's event table 455B or not (in conjunction with the consumer selections received via the user interface 447). It should be noted that the processing layer 307 may perform the filtering at any appropriate time including e.g., before the batch of events is provided to the event unloader 485B (e.g., when the event unloaders 485A and 485B are being created).

In some embodiments, the filtering may be performed by the resource coordination layer 306. The resource coordination layer 306 may be divided into two categories: foreground (FG) and background (BG) instances. While FG instances are responsible for handling customer queries (including compilation and query lifecycle management), BG instances are responsible for running a variety of background services including instance health management, updating load balancer configurations, and orchestration tasks themselves. BG instances may be partitioned into dedicated clusters for provisioning services, core background services and compute tasks, etc. As shown in FIG. 5D, a BG cluster may include BG telemetry logic instances 1 and 2, where each BG telemetry logic instance may perform any filtering as necessary and provide the events to a respective event table. In the example of FIG. 5D, the BG telemetry logic instance 1 may write all of the batch of events generated by the application 445 into the consumer event table 455A. The BG telemetry logic instance 2 may filter the batch of events generated by application 445 using the set of telemetry definitions 471 to filter out all events from the batch of events that the consumer has and opted not to share with the provider. The BG telemetry logic instance 2 may then write those events that are not filtered out to the provider event table 455B.

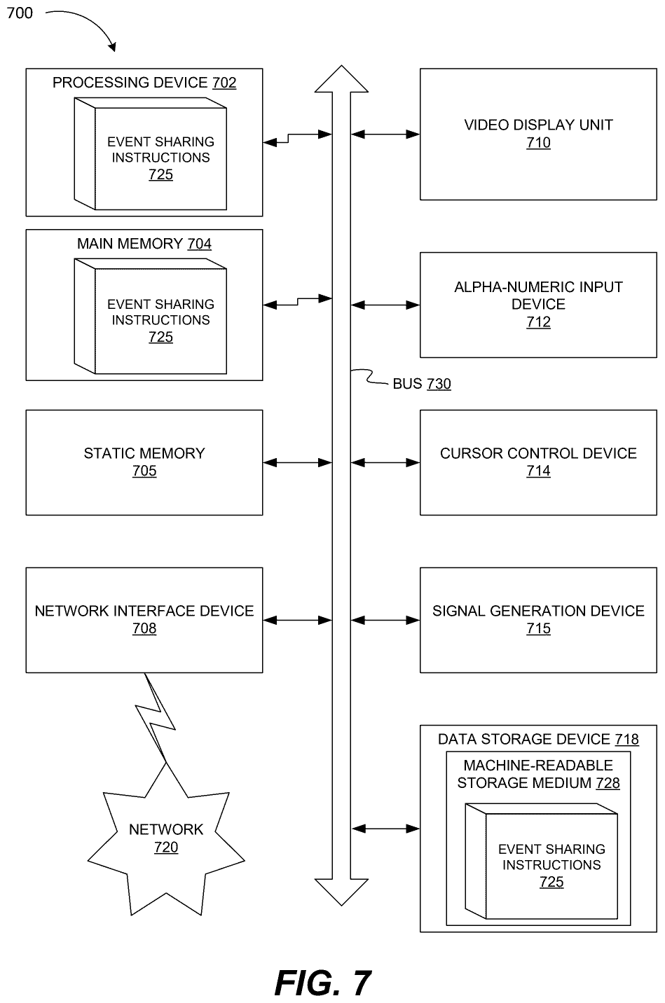

FIG. 7 illustrates a diagrammatic representation of a machine in the example form of a computer system 700 within which a set of instructions is included, the instructions to cause the machine to perform any of the methodologies discussed herein for selectively sharing with a provider account of a data exchange, events generated by an application shared by the provider account via the data exchange.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative of a server.

The exemplary computer system 700 includes a processing device 702, a main memory 704 (e.g., read-only memory (ROM), flash memory, dynamic random access memory (DRAM), a static memory 705 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 700 may further include a network interface device 708 which may communicate with a network 720. The computing device 700 also may include a video display unit 710 (e.g., a liquid crystal display (LCD) or a cathode ray tube (CRT)), an alpha-numeric input device 712 (e.g., a keyboard), a cursor control device 714 (e.g., a mouse) and an acoustic signal generation device 715 (e.g., a speaker). In one embodiment, video display unit 710, alphanumeric input device 712, and cursor control device 714 may be combined into a single component or device (e.g., an LCD touch screen).

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute event sharing instructions 725, for performing the operations and steps discussed herein.

The data storage device 718 may include a machine-readable storage medium 728, on which is stored one or more sets of event sharing instructions 725 (e.g., software) embodying any one or more of the methodologies of functions described herein. The event sharing instructions 725 may also reside, completely or at least partially, within the main memory 704 or within the processing device 702 during execution thereof by the computer system 700; the main memory 704 and the processing device 702 also constituting machine-readable storage media. The event sharing instructions 725 may further be transmitted or received over a network 720 via the network interface device 708.

The machine-readable storage medium 728 may also be used to store instructions to perform a method for sharing events generated from a native application being shared by a provider account and executed by a consumer account, as described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “granting,” “determining,” “publishing,” “providing,” “designating,” “encoding,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned (including via virtualization) and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams or flow diagrams, and combinations of blocks in the block diagrams or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
defining a set of telemetry definitions for a data listing via which an application is shared by a provider account of a data sharing platform, wherein each of the set of telemetry definitions specifies a type of event generated by the application and a corresponding sharing requirement for the type of event;
persisting the set of telemetry definitions as metadata associated with the data listing;
installing the application in a consumer account of the data exchange; and
in response to the application generating a plurality of events, sharing, by a processing device, a subset of the plurality of events with the provider account, wherein the subset of the plurality events that is shared is based at least in part on the set of telemetry definitions.

2. The method of claim 1, wherein the sharing requirement for each telemetry definition of the set of telemetry definitions indicates whether sharing of the corresponding type of event is mandatory or optional.

3. The method of claim 2, further comprising:
in response to the application being installed in the consumer account, providing a user interface (UI) via which the consumer account can enable or disable event sharing for each type of event for which sharing is optional based on the set of telemetry definitions.

4. The method of claim 3, further comprising:
receiving, via the UI, a selection of whether to enable or disable event sharing for each type of event for which sharing is optional based on the set of telemetry definitions.

5. The method of claim 4, wherein sharing the subset of the plurality of events with the provider account comprises:
filtering the plurality of events based on the set of telemetry definitions and the received selections, to generate a filtered set of events; and
providing the filtered set of events to the provider account.

6. The method of claim 1, wherein defining the set of telemetry definitions comprises defining one or more custom telemetry definitions, wherein each custom telemetry definition comprises:
a filter comprising an expression language predicate string defining a custom telemetry type; and
a string identifying the custom telemetry type.

7. The method of claim 1, wherein the data listing comprises an application package for sharing the application, and wherein the set of telemetry definitions are defined during creation of a version of the application package and are persisted as version metadata in a data persistence object of the data listing.

8. The method of claim 1, wherein each of the plurality of events is one of the following types: errors and warnings, metrics, usage logs, debug logs, and query audit logs.

9. A system comprising:
a memory; and
a processing device operatively coupled to the memory, the processing device to:
define a set of telemetry definitions for a data listing via which an application is shared by a provider account of a data sharing platform, wherein each of the set of telemetry definitions specifies a type of event generated by the application and a corresponding sharing requirement for the type of event;
persist the set of telemetry definitions as metadata associated with the data listing;
install the application in a consumer account of the data exchange; and
in response to the application generating a plurality of events, share a subset of the plurality of events with the provider account, wherein the subset of the plurality events that is shared is based at least in part on the set of telemetry definitions.

10. The system of claim 9, wherein the sharing requirement for each telemetry definition of the set of telemetry definitions indicates whether sharing of the corresponding type of event is mandatory or optional.

11. The system of claim 10, wherein the processing device is further to:
in response to the application being installed in the consumer account, provide a user interface (UI) via which the consumer account can enable or disable event sharing for each type of event for which sharing is optional based on the set of telemetry definitions.

12. The system of claim 11, wherein the processing device is further to:
receive, via the UI, a selection of whether to enable or disable event sharing for each type of event for which sharing is optional based on the set of telemetry definitions.

13. The system of claim 12, wherein to share the subset of the plurality of events with the provider account, the processing device is to:
filter the plurality of events based on the set of telemetry definitions and the received selections, to generate a filtered set of events; and
provide the filtered set of events to the provider account.

14. The system of claim 9, wherein defining the set of telemetry definitions comprises defining one or more custom telemetry definitions, wherein each custom telemetry definition comprises:
a filter comprising an expression language predicate string defining a custom telemetry type; and
a string identifying the custom telemetry type.

15. The system of claim 9, wherein the data listing comprises an application package for sharing the application, and wherein the processing device defines the set of telemetry definitions during creation of a version of the application package and persists the set of telemetry definitions as version metadata in a data persistence object of the data listing.

16. The system of claim 9, wherein each of the plurality of events is one of the following types: errors and warnings, metrics, usage logs, debug logs, and query audit logs.

17. A non-transitory computer-readable medium having instructions stored thereon which, when executed by a processing device, cause the processing device to:
define a set of telemetry definitions for a data listing via which an application is shared by a provider account of a data sharing platform, wherein each of the set of telemetry definitions specifies a type of event generated by the application and a corresponding sharing requirement for the type of event;
persist the set of telemetry definitions as metadata associated with the data listing;
install the application in a consumer account of the data exchange; and
in response to the application generating a plurality of events, share by the processing device, a subset of the plurality of events with the provider account, wherein the subset of the plurality events that is shared is based at least in part on the set of telemetry definitions.

18. The non-transitory computer-readable medium of claim 17, wherein the sharing requirement for each telemetry definition of the set of telemetry definitions indicates whether sharing of the corresponding type of event is mandatory or optional.

19. The non-transitory computer-readable medium of claim 18, wherein the processing device is further to:
in response to the application being installed in the consumer account, provide a user interface (UI) via which the consumer account can enable or disable event sharing for each type of event for which sharing is optional based on the set of telemetry definitions.

20. The non-transitory computer-readable medium of claim 19, wherein the processing device is further to:
receive, via the UI, a selection of whether to enable or disable event sharing for each type of event for which sharing is optional based on the set of telemetry definitions.

21. The non-transitory computer-readable medium of claim 20, wherein to share the subset of the plurality of events with the provider account, the processing device is to:
filter the plurality of events based on the set of telemetry definitions and the received selections, to generate a filtered set of events; and
provide the filtered set of events to the provider account.

22. The non-transitory computer-readable medium of claim 17, wherein defining the set of telemetry definitions comprises defining one or more custom telemetry definitions, wherein each custom telemetry definition comprises:
a filter comprising an expression language predicate string defining a custom telemetry type; and
a string identifying the custom telemetry type.

23. The non-transitory computer-readable medium of claim 17, wherein the data listing comprises an application package for sharing the application, and wherein the processing device defines the set of telemetry definitions during creation of a version of the application package and persists the set of telemetry definitions as version metadata in a data persistence object of the data listing.

24. The non-transitory computer-readable medium of claim 17, wherein each of the plurality of events is one of the following types: errors and warnings, metrics, usage logs, debug logs, and query audit logs.
